(19) United States
(12) Patent Application Publication
(10) Pub. No.: US 2025/0293392 A1
(43) Pub. Date: Sep. 18, 2025

(54) BATTERY MODULE

(71) Applicant: SAMSUNG SDI CO., LTD., Yongin-si (KR)

(72) Inventor: Gang Yul KIM, Suwon-si (KR)

(21) Appl. No.: 18/830,383

(22) Filed: Sep. 10, 2024

(30) Foreign Application Priority Data
Mar. 12, 2024 (KR) 10-2024-0034424

(51) Int. Cl. H01M 50/383; H01M 50/209; H01M 50/342; H01M 50/502

(52) U.S. Cl. CPC H01M 50/383; H01M 50/209; H01M 50/3425; H01M 50/502

(57) ABSTRACT

The present disclosure relates to a battery module capable of preventing or reducing chain ignition of battery cells. To this end, the present disclosure provides a battery module including a housing, a plurality of battery cells disposed inside the housing and each including a vent hole and a vent plate, a blocking member disposed to face the battery cell and configured to cover the vent plate, and a fixing member configured to fix the blocking member to the battery cell.

### CROSS-REFERENCE TO RELATED APPLICATION

The present application claims priority to and the benefit of Korean Patent Application No. 10-2024-0034424, filed on Mar. 12, 2024, in the Korean Intellectual Property Office, the entire disclosure of which is incorporated herein by reference.

### BACKGROUND

### 1. Field

Aspects of embodiments of the present disclosure relate to a battery module.

### 2. Description of the Related Art

Unlike primary batteries that cannot be recharged, secondary batteries are batteries that can be (e.g., repeatedly) charged and discharged. Low-capacity secondary batteries are used in small portable electronic devices such as smartphones, feature phones, laptop computers, digital cameras, and camcorders, and high-capacity secondary batteries are widely used as power storage batteries and power sources for driving motors in hybrid vehicles, electric vehicles, and the like. Such a secondary battery includes an electrode assembly including a positive electrode and a negative electrode, a case for accommodating the same, and an electrode terminal connected to the electrode assembly.

Secondary batteries may be used as battery modules or battery packs formed of a plurality of unit battery cells connected in series and/or parallel to provide high energy density. A battery module or battery pack may be formed by connecting electrode terminals of a plurality of unit cells to each other to meet the desired or required amount of power and, for example, to implement a high-power secondary battery for an electric vehicle.

The above-described information is provided to enhance understanding of the background of the present disclosure, and thus may include information that does not constitute the related (or prior) art.

### SUMMARY

An aspect according to embodiments of the present disclosure is directed towards a battery module capable of preventing chain ignition of battery cells.

These and other aspects and features of the present disclosure will be described in or will be apparent from the following description of some embodiments of the present disclosure.

According to one or more embodiments of the present disclosure, a battery module includes a housing, a plurality of battery cells inside the housing and each including a vent hole and a vent plate, a blocking member disposed to face the plurality of battery cells and configured to cover each of the vent plates (the plurality of vent plates), and a fixing member configured to fix the blocking member to the plurality of battery cells.

The blocking member may include a first body seated on the plurality of battery cells, a plurality of capsules protruding from the first body and each arranged to face one of the plurality of vent plates, a blocking material inside each of the plurality of capsules, and a second body facing the first body and configured to seal the plurality of capsules.

The first body and the second body may be joined to each other along a joint line arranged to surround an opening of the plurality of capsules.

The blocking material may be injected into the plurality of capsules in a liquid state and then cured.

The blocking material may include at least one selected from among silicone, epoxy, and polyurethane.

Each of the plurality of capsules may be inserted into a corresponding vent hole of the plurality of vent holes.

An edge of the plurality of capsules may be curved to have a curvature.

The plurality of capsules may be in contact with the plurality of vent plates.

Each of the plurality of vent plates may include a fracture portion which protrudes toward a corresponding vent hole of the plurality of vent holes and is configured to be fractured as an internal pressure of a corresponding battery cell of the plurality of battery cells rises to a set pressure or more, and each of the plurality of capsules may include a groove into which the fracture portion is inserted.

The fixing member may include a cell sheet between the first body and the plurality of battery cells and having two opposing surfaces fixed to the first body and the plurality of battery cells, respectively.

A longitudinal direction of the cell sheet may be parallel to an arrangement direction of the plurality of capsules.

The cell sheet may be provided as (e.g., may include) a pair of cell sheets, and the pair of cell sheets may each be arranged at one of two opposing sides of the plurality of capsules.

The blocking member may further include a hinge connected to the first body and the second body and configured to support the second body to be rotatable with respect to the first body.

The battery module may further include a busbar holder inside the housing and configured to support a busbar electrically connected to the plurality of battery cells, wherein a central axis of the hinge may be between the second body and the busbar holder.

The battery module may further include a support member between the plurality of battery cells and the busbar holder and configured to support the busbar holder with respect to the plurality of battery cells.

The support member may be elastically deformable.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a schematic exploded perspective view illustrating the configuration of a battery module according to an embodiment of the present disclosure;

FIG. 2 is a schematic cross-sectional view illustrating the configuration of the battery module according to an embodiment of the present disclosure;

FIG. 3 is a schematic perspective view illustrating the configuration of a battery cell according to an embodiment of the present disclosure;

FIG. 4 is a schematic cross-sectional view illustrating the configuration of the battery cell according to an embodiment of the present disclosure;

FIG. 5 is a schematic cross-sectional view illustrating the configuration of a vent plate according to an embodiment of the present disclosure;

FIG. 6 is a schematic plan view illustrating the configuration of the vent plate according to an embodiment of the present disclosure;

FIG. 7 is a schematic perspective view illustrating the configuration of a blocking member according to an embodiment of the present disclosure;

FIG. 8 is a perspective view illustrating the configuration of the blocking member according to an embodiment of the present disclosure from a different viewpoint from FIG. 7;

FIG. 9 is a schematic side view illustrating the configuration of the blocking member according to an embodiment of the present disclosure;

FIG. 10 is a schematic plan view illustrating the configuration of the blocking member according to an embodiment of the present disclosure;

FIG. 11 is a schematic exploded perspective view illustrating the configuration of the blocking member according to an embodiment of the present disclosure;

FIG. 12 is an exploded perspective view illustrating the configuration of the blocking member according to an embodiment of the present disclosure from a different viewpoint from FIG. 11;

FIG. 13 is a schematic view illustrating a contact state between a capsule and a vent plate according to an embodiment of the present disclosure;

FIG. 14 is a schematic enlarged view illustrating the configuration of a hinge according to an embodiment of the present disclosure; and

FIG. 15 is a schematic enlarged view illustrating the configuration of a support member according to an embodiment of the present disclosure.

### DETAILED DESCRIPTION

Herein, some embodiments of the present disclosure will be described, in further detail, with reference to the accompanying drawings. The terms or words used in this specification and claims should not be construed as being limited to the usual or dictionary meaning and should be interpreted to have a meaning and concept consistent with the technical idea of the present disclosure based on the principle that the inventor can be his/her own lexicographer to appropriately define the concept of the term.

The embodiments described in this specification and the configurations shown in the drawings are provided as example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” “linked to,” or “coupled to” another element or layer, it may be directly on, connected, linked to, or coupled to the other element or layer or one or more intervening elements or layers may also be present. When an element or layer is referred to as being “directly on,” “directly connected to,” “directly linked to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, components, and/or groups, but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned or disposed) on the “above (or below)” or “on (or under)” a component, it may refer to that the arbitrary element is placed in contact with the upper (or lower) surface of the component and may also refer to that another component may be interposed between the component and any arbitrary element arranged (or located or positioned or disposed) on (or under) the component.

In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it refers to A, B, or A and B, unless otherwise stated. That is, “and/or” includes any or all combinations of a plurality of items enumerated. When “C to D” is stated, it refers to C or more and D or less, unless otherwise specified.

The terms used in the present specification are for describing embodiments of the present disclosure and are not intended to limit the scope of the present disclosure.

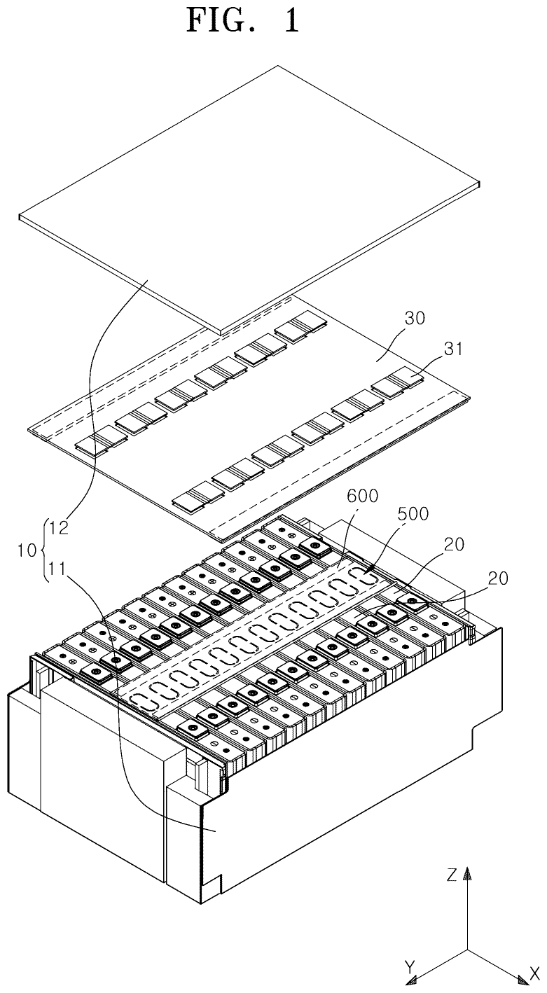

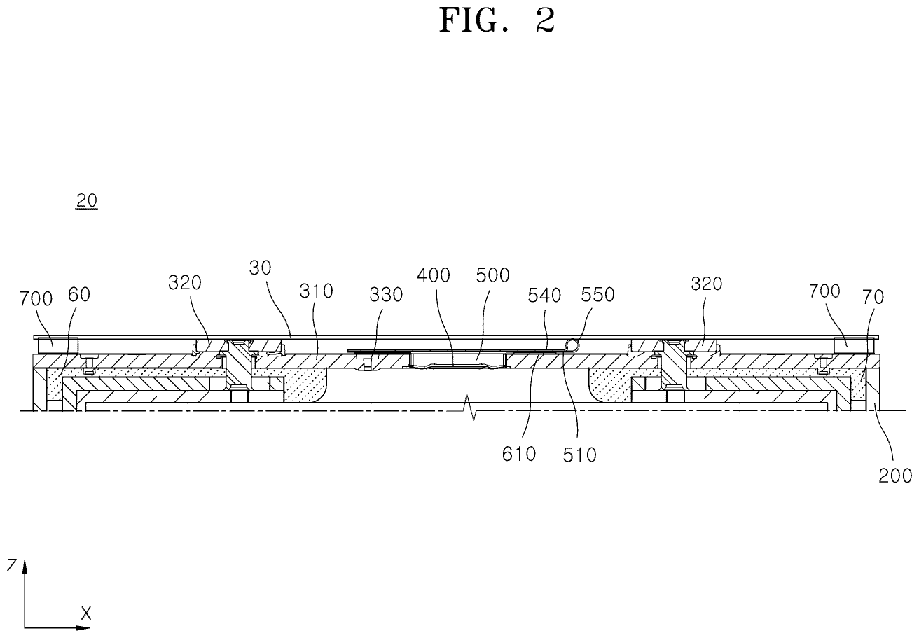

FIG. 1 is a schematic exploded perspective view illustrating a configuration of a battery module according to an embodiment of the present disclosure. FIG. 2 is a schematic cross-sectional view illustrating the configuration of the battery module according to an embodiment of the present disclosure.

Referring to FIGS. 1 and 2, the battery module according to the present embodiment includes a housing 10, a battery cell 20, a blocking member 500, and a fixing member 600.

The housing 10 may function as a component that supports the battery cell 20 and protects the battery cell 20 from external shocks and foreign materials. The housing 10 may provide a space for accommodating the battery cell 20 therein.

The housing 10 may include a housing body 11 and a housing cover 12.

The housing body 11 may be formed to have a hollow box shape with one open side (e.g., an opening on one side). For example, the open side of the housing body 11 may be disposed to face upward in FIG. 1. A cross-sectional shape of the housing body 11 is not limited to a quadrangular shape shown in FIG. 1 and may be designed to be changed into various suitable shapes such as a polygonal shape, a circular shape, and an oval shape.

The housing cover 12 may be coupled to the housing body 11 and may close an internal space of the housing body 11. As an example, the housing cover 12 may be formed to have an approximately plate shape. The housing cover 12 may be disposed to face the open side of the housing body 11, for example, an upper surface of the housing body 11. The housing cover 12 may be fixed to the housing body 11 through various types of coupling methods including bolting, welding, fitting, and the like.

The battery cell 20 may function as a unit structure that stores and supplies power in and from the battery module. The battery cell 20 may be disposed inside the housing 10.

One or more battery cells 20 may be provided. Although an example in which a plurality of battery cells 20 are provided is shown in FIG. 1, the present disclosure is not limited thereto, and one (e.g., a single) battery cell 20 may also be provided.

When the plurality of battery cells 20 are provided, the plurality of battery cells 20 may be arranged in a plurality of columns inside the housing 10. As an example, the plurality of battery cells 20 may be arranged in a plurality of columns in a longitudinal direction of the housing 10 (Y-axis direction in FIG. 1). However, the arrangement form of the plurality of battery cells 20 is not limited thereto. The plurality of battery cells 20 may be arranged in a plurality of columns in a width direction of the housing 10 (X-axis direction in FIG. 1) or may be arranged in a plurality of columns in the longitudinal direction and the width direction of the housing 10.

Hereinafter, an example in which the battery cell 20 is a prismatic lithium ion secondary will be described. However, the present disclosure is not limited thereto, and the battery cell 20 may be a lithium polymer battery or a cylindrical battery.

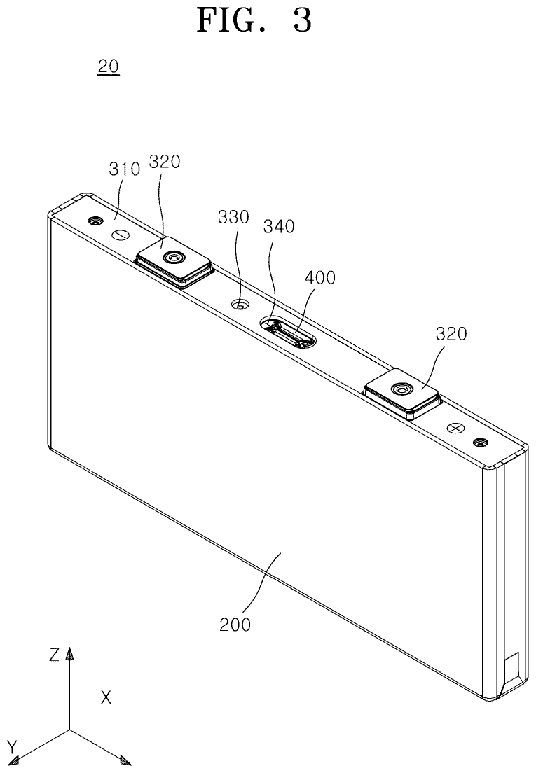

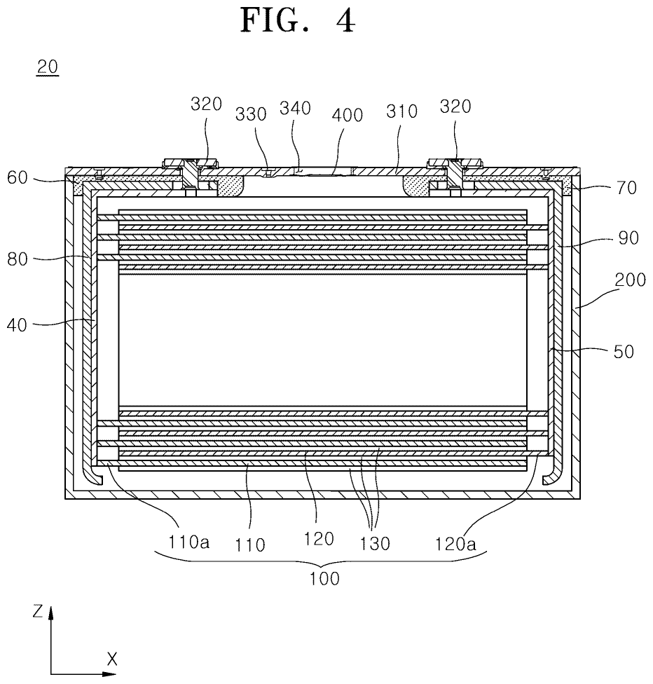

FIG. 3 is a schematic perspective view illustrating the configuration of the battery cell 20 according to an embodiment of the present disclosure. FIG. 4 is a schematic cross-sectional view illustrating the configuration of the battery cell 20 according to an embodiment of the present disclosure.

Referring to FIGS. 3 and 4, the battery cell 20 includes an electrode assembly 100, a cell case 200, a cap plate 310, and a vent plate 400.

The electrode assembly 100 may include a separator 130 disposed between a positive electrode 110 and a negative electrode 120.

The positive electrode 110 and the negative electrode 120 may include coated portions which are areas in which an active material is applied on a current collector made of a thin metal foil, and uncoated portions 110a and 120a which are areas uncoated with the active material.

The electrode assembly 100 may be formed in the form of a jelly roll in which the separator 130, which is an insulator, is interposed between the positive electrode 110 and the negative electrode 120, and then the separator 130, the positive electrode 110, and the negative electrode 120 are wound. However, the present disclosure is not limited to the form, and the electrode assembly 100 may have a stack structure in which the positive electrode 110 and the negative electrode 120, which each includes a plurality of sheets, are alternately stacked with the separator 130 interposed therebetween.

The electrode assembly 100 may be formed singly or may be provided as a plurality of electrode assemblies 100.

The cell case 200 may form the overall exterior of the battery cell 20. The cell case 200 may accommodate the electrode assembly 100 therein. As an example, the cell case 200 may be formed to have a rectangular parallelepiped shape with an open surface (e.g., an opening on one surface). The open surface of the cell case 200 may be disposed to vertically face the housing cover 12 inside the housing 10.

The cell case 200 may include a conductive metal material such as aluminum, an aluminum alloy, or nickel-plated steel.

The cap plate 310 may be coupled to the cell case 200 and may seal the cell case 200. As an example, the cap plate 310 may be formed to have a plate shape. The cap plate 310 may be disposed on the cell case 200 to cover an open side of the cell case 200. The cap plate 310 may be coupled to the cell case 200 through various types of coupling methods including welding, bolting, fitting, and the like. The cap plate 310 may be made of a conductive material including at least one selected from aluminum and an aluminum alloy.

The cap plate 310 may include a terminal 320.

The terminal 320 may be installed to pass though the cap plate 310 and protrude to the outside of the cap plate 310. An outer peripheral surface of an upper pillar (e.g., upper cylindrical portion) of the terminal 320 may be threaded so as to be fixed to the cap plate 310 through a nut. However, the present disclosure is not limited thereto, and the terminal 320 may have a rivet structure so as to be riveted or may be welded and coupled to the cap plate 310.

The terminal 320 protruding to the outside of the cap plate 310 may be provided as a pair of terminals 320. The pair of terminals 320 may be individually connected to the positive electrode 110 and the negative electrode 120 of the electrode assembly 100. Accordingly, the pair of terminals 320 may each function as one of a positive terminal and a negative terminal of the battery cell 20.

As an example, the terminals 320 may be electrically connected to current collectors including first and second current collectors 40 and 50 (hereinafter referred to as positive and negative electrode current collectors) joined to a positive electrode uncoated portion 110a and a negative electrode uncoated portion 120a through welding. For example, the pair of terminals 320 may each be connected to one of the positive and negative current collectors 40 and 50 through welding. However, the present disclosure is not limited thereto, and the terminals 320 and the positive and negative current collectors 40 and 50 may be formed by being integrally coupled.

The cap plate 310 may further include an electrolyte injection port 330 in which a sealing stopper may be installed.

The cap plate 310 may further include a vent hole 340.

The vent hole 340 may be formed to have the shape of a hole (e.g., opening or through hole) passing through both surfaces (e.g., both upper and lower surfaces) of the cap plate 310. The vent hole 340 may function as a component that provides a path through which flames, gases, smoke, or the like generated inside the cell case 200 are discharged from the battery cell 20 during thermal runaway of the battery cell 20. A lower side of the vent hole 340 may be connected to an internal space (e.g., inside) of the cell case 200. An upper side of the vent hole 340 may be connected to an external space of (e.g., beyond) the cap plate 310. A cross-sectional shape of the vent hole 340 may be designed to be (e.g., changed into) various suitable shapes such as an oval shape, a circular shape, and a polygonal shape.

The vent plate 400 may be opened or closed in response to a change in the internal pressure of the cell case 200. That is, the vent plate 400 may remain closed to seal the cell case 200 during a normal operation of the battery cell 20. The vent plate 400 may be opened as the internal pressure of the cell case 200 rises to a set magnitude or more due to overcharging of the battery cell 20 or an outbreak of fire and may discharge flames, gases, smoke, or the like generated from the inside of the cell case 200 to the outside of the cell case 200.

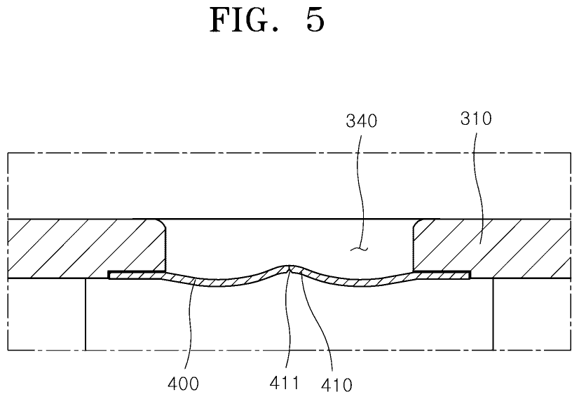

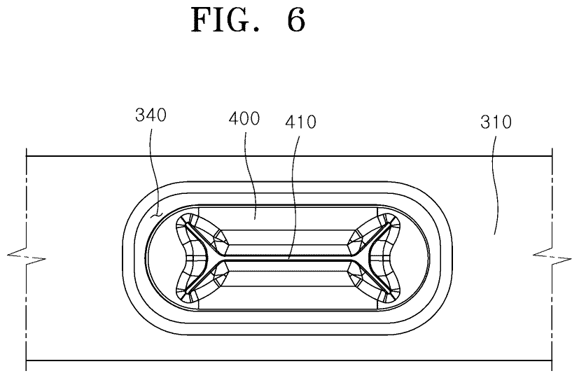

FIG. 5 is a schematic cross-sectional view illustrating the configuration of the vent plate 400 according to an embodiment of the present disclosure. FIG. 6 is a schematic plan view illustrating the configuration of the vent plate 400 according to an embodiment of the present disclosure.

Referring to FIGS. 5 and 6, the vent plate 400 according to the present embodiment may be formed to have a plate shape. The vent plate 400 may be disposed to face a lower end of the vent hole 340. An area of the vent plate 400 may be larger than a cross-sectional area of the vent hole 340. An upper surface of the vent plate 400 may be coupled to a lower surface of the cap plate 310 through various suitable types of coupling methods including welding, bolting, fitting, and the like.

The vent plate 400 may include a fracture portion 410.

The fracture portion 410 may form a partial exterior (e.g., a portion of the exterior) of the vent plate 400. The fracture portion 410 may be fractured as the internal pressure of the cell case 200 rises to a set pressure or more and thus may open the vent plate 400.

As an example, the fracture portion 410 may protrude from the upper surface of the vent plate 400 toward the vent hole 340. The fracture portion 410 may be formed such that a width becomes narrower toward an upper end portion (e.g., having a narrower top portion and a broader base portion). The fracture portion 410 may be cut to both sides with respect to the upper end portion by pressure applied from the internal space of the cell case 200. For example, the upper end portion of the fracture portion 410 may be cut open by the pressure applied from the internal space of the cell case 200. A notch 411 may be formed in an inner surface of the upper end portion of the fracture portion 410 to induce a fracture action of the fracture portion 410. A cross-sectional shape of the fracture portion 410 is not limited to the shape shown in FIG. 5 and may be formed to form various suitable patterns on the vent plate 400.

An insulating member (e.g., an insulator) may be installed between the electrode assembly 100 and the cap plate 310. The insulating member may include first and second lower insulating members 60 and 70, and each of the first and second lower insulating members 60 and 70 may be installed between the electrode assembly 100 and the cap plate 310.

A separation member (e.g., a separator) may be installed to face a side surface of the electrode assembly 100 and an end portion of the separation member may be installed between the insulating member and the terminal 320.

The separation member may include first and second separation members 80 and 90.

One end portion of each of the first and second separation members 80 and 90 that may be installed to face one side surface of the electrode assembly 100 may be installed between the first and second lower insulating members 60 and 70 and the pair of terminals 320.

The terminals 320 welded and coupled to the positive and negative current collectors 40 and 50 may be coupled to one end portion of the first and second lower insulating members 60 and 70 and the first and second separation members 80 and 90.

The battery module according to the present embodiment may further include a busbar holder 30.

The busbar holder 30 may be disposed inside the housing 10 and may function as a component that supports a busbar 31.

The busbar holder 30 according to the present embodiment may be formed to have a plate shape. The busbar holder 30 may be disposed such that an upper surface faces the housing cover 12, and a lower surface faces an upper surface of the battery cell 20, for example, the cap plate 310. The busbar holder 30 may be formed to include an electrically insulating polymer (e.g., polymer compound) material.

The busbar 31 may be electrically connected to the battery cell 20. The busbar 31 may be fixed to the busbar holder 30 through various types of suitable coupling methods including welding, bolting, fitting, and the like. The busbar 31 may be in contact with the terminal 320 of the battery cell 20. The busbar 31 may include a conductive material such as aluminum, nickel, or copper to be electrically connectable to the terminal 320.

A plurality of busbars 31 may be provided. The plurality of busbars 31 may connect the plurality of battery cells 20 in series or parallel. The number and arrangement of the plurality of busbars 31 may be designed to be changed in various suitable ways according to the connection structures (e.g., series and parallel connection structures) of the battery cells 20.

The blocking member (e.g., a vent plate cover) 500 may be disposed to face the battery cell 20 and may cover the vent plate 400.

The blocking member 500 may function as a component that blocks flames, gases, smoke, or the like generated outside the battery cell 20 from flowing into the vent hole 340 or coming into direct contact with the vent plate 400. Accordingly, when a fire occurs in any one of the battery cells 20, the blocking member 500 may prevent chain ignition of the plurality of battery cells 20 due to flames, gases, smoke, or the like flowing into the vent holes 340 of adjacent battery cells 20.

The blocking member 500 may be separated from the cap plate 310 by flames, heat, and pressure of gas generated inside the battery cell 20. Accordingly, in the event of a thermal runaway of any one battery cell 20, the blocking member 500 may guide flames, gases, or the like generated from the battery cell 20 to be smoothly discharged to the outside.

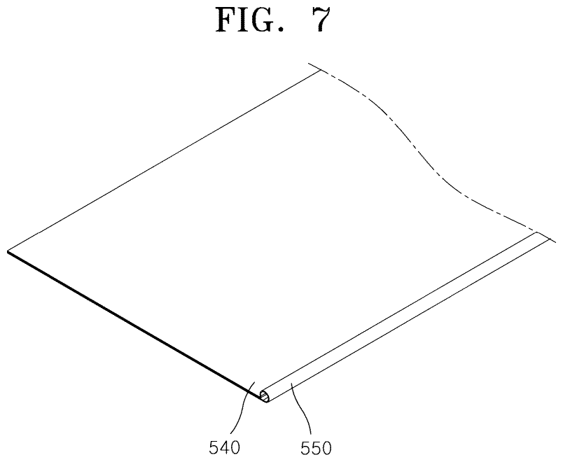

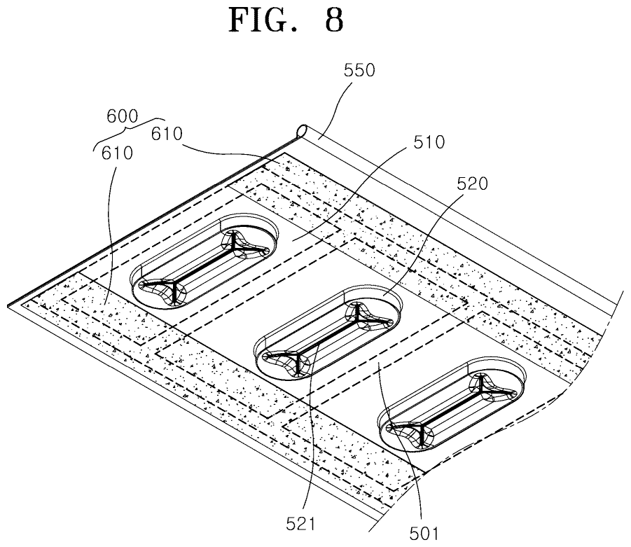

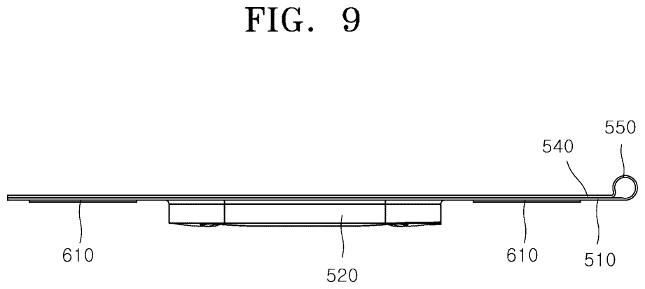

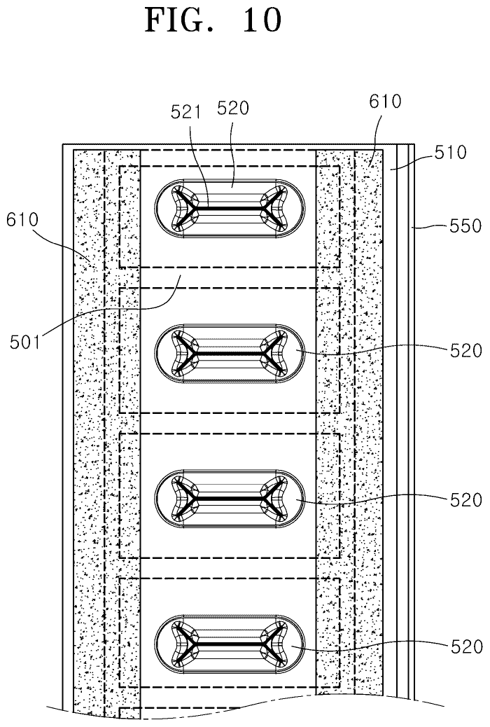

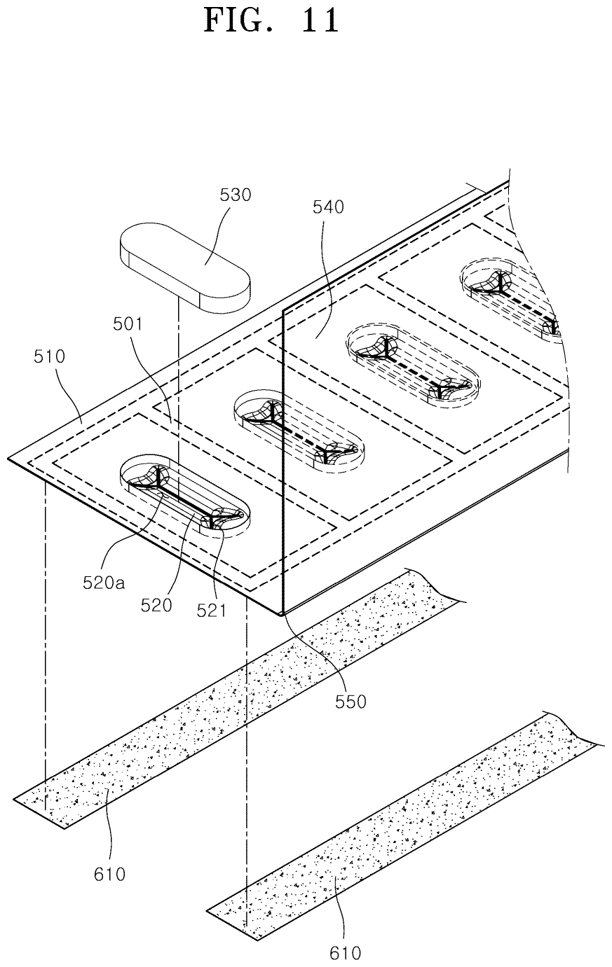

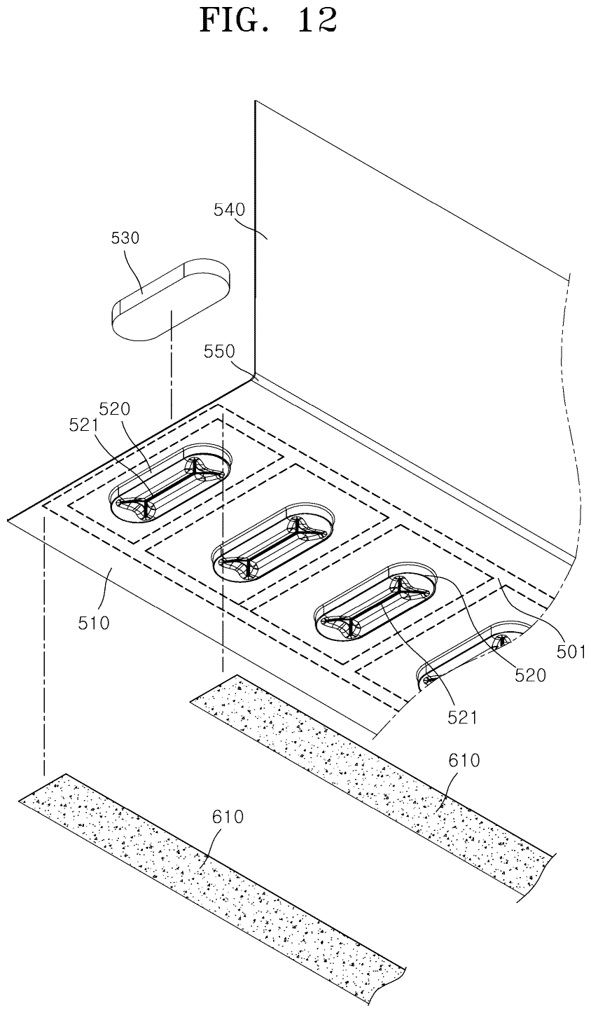

FIG. 7 is a schematic cross-sectional view illustrating the configuration of the blocking member 500 according to an embodiment of the present disclosure. FIG. 8 is a perspective view illustrating the configuration of the blocking member 500 according to an embodiment of the present disclosure from a different viewpoint from FIG. 7. FIG. 9 is a schematic side view illustrating the configuration of the blocking member 500 according to an embodiment of the present disclosure. FIG. 10 is a schematic plan view illustrating the configuration of the blocking member 500 according to an embodiment of the present disclosure. FIG. 11 is a schematic exploded perspective view illustrating the configuration of the blocking member 500 according to an embodiment of the present disclosure. FIG. 12 is an exploded perspective view illustrating the configuration of the blocking member 500 according to an embodiment of the present disclosure from a different viewpoint from FIG. 11.

Referring to FIGS. 1 to 12, the blocking member 500 may include a first body 510, a capsule 520, a blocking material 530, and a second body 540.

The first body 510 may form one side exterior of the blocking member 500 and may entirely support the capsule 520, the blocking material 530, and the second body 540.

As an example, the first body 510 may be formed to have a plate shape with a rectangular cross-sectional shape. A longitudinal direction of the first body 510 may be parallel to the longitudinal direction of the housing 10 (Y-axis direction in FIG. 1). A length of the first body 510 may be greater than or equal to the sum of lengths of the battery cells 20 parallel to the longitudinal direction of the housing 10.

The first body 510 may be disposed above the battery cell 20. A lower surface of the first body 510 may be disposed to face the upper surfaces of the cap plates 310 of the plurality of battery cells 20 arranged in the longitudinal direction of the housing 10. A width of the first body 510 parallel to the width direction of the housing 10 (X-axis direction in FIG. 1) may be greater than a width of the vent hole 340 parallel to the width direction of the housing 10 and may be less than a distance between the pair of terminals 320. Accordingly, a central portion of the first body 510 may be disposed to face an upper end of the vent hole 340, and an edge of the first body 510 may be disposed to face an upper surface of the cap plate 310. The first body 510 may be made of a polymer (e.g., polymer compound) material.

The capsule 520 may protrude from the first body 510 toward the vent hole 340 and may be disposed to face the vent plate 400.

As an example, the capsule 520 may protrude downward from a lower surface of the central portion of the first body 510. An internal space of the capsule 520 may be formed to be empty (e.g., a void). An opening 520a may be formed in an upper side of the capsule 520 to pass through an upper surface of the first body 510 and open (e.g., expose) the internal space of the capsule 520. The capsule 520 may be made of a polymer (e.g., polymer compound) material.

A plurality of capsules 520 may be provided. The plurality of capsules 520 may be arranged in a line in the longitudinal direction of the first body 510. Each capsule 520 may be arranged to individually face the vent plates 400 of different battery cells 20.

Because the first body 510 is seated on the upper surface of the cap plate 310, the capsule 520 may be inserted into the vent hole 340. A cross-sectional area of the capsule 520 may be smaller than or equal to the cross-sectional area of the vent hole 340. A cross-sectional shape of the capsule 520 may be formed to be the same or substantially the same as the cross-sectional shape of the vent hole 340. An edge of a lower end portion of the capsule 520 may be formed to be curved to have a certain curvature. That is, the edge of the lower end portion of the capsule 520 may have a curved shape. Accordingly, the capsule 520 may be more smoothly inserted into the vent hole 340.

A lower surface of the capsule 520 may be in contact with the vent plate 400.

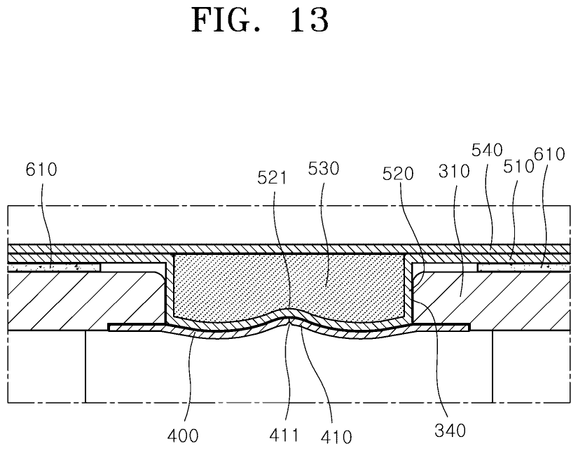

FIG. 13 is a schematic view illustrating a contact state between the capsule 520 and the vent plate 400 according to an embodiment of the present disclosure.

Referring to FIGS. 1 to 13, a groove (e.g., opening or cut) 521 may be formed in an area of the lower surface of the capsule 520 which faces the fracture portion 410 of the vent plate 400.

The groove 521 may be formed to have a groove shape that is formed to be concavely recessed upward from the lower surface of the capsule 520. A cross-sectional shape of the groove 521 may be formed to correspond to the cross-sectional shape of the fracture portion 410. Because the lower surface of the capsule 520 is in contact with the vent plate 400, the fracture portion 410 may be inserted into the groove 521. An outer surface of the fracture portion 410 may be in contact (e.g., in close contact) with an inner surface of the groove 521. Accordingly, the groove 521 expands a contact area (e.g., provides an expanded contact area) between the capsule 520 and the vent plate 400, thereby preventing or substantially preventing the capsule 520 from being separated from the vent hole 340 due to external vibrations or the like.

The blocking material 530 may be disposed inside the capsule 520. The blocking material 530 may function as a component that physically blocks foreign materials from entering (e.g., flowing) from the outside of the battery cell 20 and reinforces the heat resistance performance of the blocking member 500.

A plurality of blocking materials 530 may be provided. The plurality of blocking materials 530 may be individually disposed inside different capsules 520.

The blocking material 530 may be injected into the capsule 520 in a liquid state through the opening 520a and then may be cured into a solid state. Accordingly, the internal space of the capsule 520 may be filled (e.g., tightly filled) with the blocking material 530 irrespective of the curvature, cross-sectional shape, and the like of the capsule 520. The blocking material 530 may include a high heat-resistant material, for example, at least one selected from among silicone, epoxy, and polyurethane.

The second body 540 may be disposed to face the first body 510 and may form the other side exterior of the blocking member 500. The second body 540 may function as a component that covers the opening 520a of the capsule 520 and seals the capsule 520.

As an example, the second body 540 may be formed to have a plate shape. A lower surface of the second body 540 may be seated on the upper surface of the first body 510. The second body 540 may be made of a polymer (e.g., polymer compound) material.

The first body 510 and the second body 540 may be joined to each other along a joint line 501. The joint line 501 may be an area in which the first body 510 and the second body 540 are physically joined to each other among the entire area of the first body 510 and the second body 540. The joint line 501 may be disposed to individually surround the opening 520a of each of the plurality of capsules 520. As an example, the joint line 501 may have a shape extending in the form of a ladder grid in the longitudinal direction of the first body 510. Accordingly, the first body 510 and the second body 540 are integrally coupled along a peripheral surface of the opening 520a, thereby preventing or substantially preventing the blocking material 530 disposed inside the capsule 520 from flowing out through the opening 520a. The first body 510 and the second body 540 may be joined to each other through various suitable types of coupling methods including friction welding, ultrasonic welding, bolting, fitting, and the like.

The blocking member 500 may further include a hinge 550.

The hinge 550 may support the second body 540 to be rotatable with respect to the first body 510. The second body 540 may rotate relative to the first body 510 about the hinge 550 and may open or close the opening 520a. Accordingly, the first body 510 and the second body 540 of the blocking member 500 may be connected as one part by the hinge 550 for ease of transportation and handling, and assembly (e.g., the assembly process) may be improved. In addition, when the first body 510 and the second body 540 are in contact with each other, the hinge 550 may fix or arrange the second body 540 at a correct position without any additional manipulation, thereby improving the efficiency of joining work.

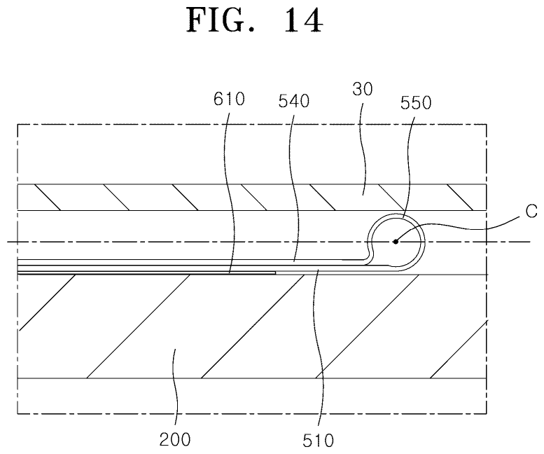

FIG. 14 is a schematic enlarged view illustrating the configuration of the hinge according to an embodiment of the present disclosure.

Referring to FIG. 14, the hinge 550 according to the present embodiment may have a ring shape of which the two ends are each connected to one of the ends of the first body 510 and the second body 540. The hinge 550 may have an approximately circular cross-sectional shape. A central axis C of the hinge 550 may be disposed between the second body 540 and the busbar holder 30. That is, the central axis C of the hinge 550 may be disposed at a higher level than the second body 540 and at a lower level than the busbar holder 30. Accordingly, the hinge 550 prevents or substantially prevents a level difference from occurring between the two ends of the first body 510 due to its own curvature and maintains the blocking member 500 in a parallel state with respect to the cap plate 310, thereby preventing or substantially preventing the capsule 520 from being separated from the vent hole 340.

The fixing member 600 may function as a component for fixing the blocking member 500 to the battery cell 20. Accordingly, the fixing member 600 may prevent the blocking member 500 from being separated from the battery cell 20 due to external vibrations, shocks, or the like.

The fixing member 600 may include a cell sheet 610.

The cell sheet 610 may be disposed between the first body 510 and the battery cell 20. As an example, the cell sheet 610 may be disposed between the first body 510 and the cap plate 310. Both (e.g., upper and lower) surfaces of the cell sheet 610 may each be fixed to one of the lower surface of the first body 510 and the upper surface of the cap plate 310.

A longitudinal direction of the cell sheet 610 may be arranged in parallel to the arrangement direction of the plurality of capsules 520, that is, the longitudinal direction of the first body 510. The length of the cell sheet 610 may be the same or substantially the same as the length of the first body 510.

The cell sheets 610 may be provided as a pair. A pair of cell sheets 610 may be disposed on both sides of the capsule 520, with the capsule 520 interposed therebetween.

The cell sheet 610 may be a double-sided tape with both sides coated with an adhesive material or an adhesive made of an adhesive material. A cross-sectional shape of the cell sheet 610 may be changed into various suitable shapes such as a circular shape, an oval shape, and a polygonal shape in addition to a rectangular shape.

A film may be attached to a lower surface of the cell sheet 610 which faces the cap plate 310. The film may function as a component that prevents or substantially prevents foreign materials or the like from being attached to an inner surface of the cell sheet 610 in a state in which the cell sheet 610 is not fixed to the cap plate 310. The film may be removed from the cell sheet 610 before the cell sheet 610 is in contact with the cap plate 310.

The battery module according to the present embodiment may further include a support member 700.

The support member 700 may be disposed between the battery cell 20 and the busbar holder 30. The support member 700 may function as a component that supports the busbar holder 30 with respect to the battery cell 20 and separates the battery cell 20 and the busbar holder 30 at a certain (e.g., set) distance. Accordingly, the support member 700 may provide a space in which the hinge 550 may be installed between the battery cell 20 and the busbar holder 30 without interference.

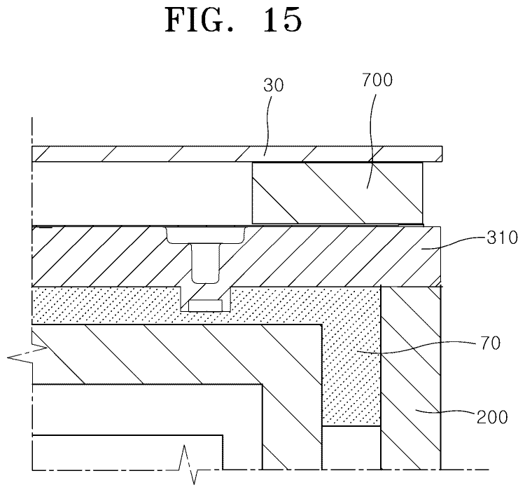

FIG. 15 is a schematic enlarged view illustrating the configuration of the support member 700 according to an embodiment of the present disclosure.

Referring to FIGS. 2 and 15, the support member 700 may be formed to have an approximately plate shape. Both (e.g., upper and lower) surfaces of the support member 700 may be in contact with a lower surface of the busbar holder 30 and the upper surface of the cap plate 310, respectively. The support member 700 may extend such that a longitudinal direction thereof is parallel to the longitudinal direction of the housing 10 (Y-axis direction in FIG. 1).

A pair of support members 700 may be provided. The pair of support members 700 may each be disposed at one of both (e.g., two opposing) sides of the busbar holder 30. The pair of support members 700 may be spaced apart from each other in the width direction of the housing 10 (X-axis direction in FIG. 1). An interval between the pair of support members 700 may be greater than an interval between the pair of terminals 320.

The support member 700 may be provided to be elastically deformable. As an example, the support member 700 may be provided to include a flexible material such as rubber or silicone. Accordingly, the support member 700 may prevent or reduce damage to the busbar holder 30 or the battery cell 20 due to vibrations or shocks applied to the busbar holder 30 or the battery cell 20.

According to the present disclosure, when a fire occurs in any one battery cell, a blocking member covering a vent plate can prevent chain ignition of a plurality of battery cells due to flames, gases, smoke, or the like flowing into vent holes of adjacent battery cells.

According to the present disclosure, in a process of seating a first body on a battery cell, a plurality of capsules can be simultaneously inserted into vent holes, thereby further improving the efficiency of assembly work (e.g., assembly process).

According to the present disclosure, assembly can be easier and the overall process time can be shortened as compared to a method of directly applying a blocking material to a vent hole of a battery cell.

According to the present disclosure, a blocking material is installed in a battery cell in a state of being injected into a capsule in advance, thereby reducing the complexity of handling chemicals.

However, the effects obtainable through the present disclosure are not limited to the above effects, and other technical effects that are not mentioned will be clearly understood by those skilled in the art from the description of the present disclosure.

While the present disclosure has been described with reference to embodiments shown in the drawings, these embodiments are merely illustrative and it should be understood that various modifications and equivalent other embodiments can be derived by those skilled in the art on the basis of the embodiments.

Therefore, the technical scope of the present disclosure should be defined by the appended claims, and equivalents thereof.

What is claimed is:

1. A battery module comprising:
a housing;
a plurality of battery cells inside the housing and comprising a plurality of vent holes and a plurality of vent plates;
a blocking member facing the plurality of battery cells and configured to cover the plurality of vent plates; and
a fixing member configured to fix the blocking member to the plurality of battery cells.

2. The battery module as claimed in claim 1, wherein the blocking member comprises:
a first body seated on the plurality of battery cells;
a plurality of capsules protruding from the first body and each arranged to face one of the plurality of vent plates;
a blocking material inside each of the plurality of capsules; and
a second body facing the first body and configured to seal the plurality of capsules.

3. The battery module as claimed in claim 2, wherein the first body and the second body are joined to each other along a joint line arranged to surround an opening of the plurality of capsules.

4. The battery module as claimed in claim 2, wherein the blocking material is injected into the plurality of capsules in a liquid state and then cured.

5. The battery module as claimed in claim 2, wherein the blocking material comprises at least one selected from among silicone, epoxy, and polyurethane.

6. The battery module as claimed in claim 2, wherein each of the plurality of capsules is inserted into a corresponding vent hole of the plurality of vent holes.

7. The battery module as claimed in claim 6, wherein an edge of the plurality of capsules is curved to have a curvature.

8. The battery module as claimed in claim 2, wherein the plurality of capsules are in contact with the plurality of vent plates.

9. The battery module as claimed in claim 8, wherein each of the plurality of vent plates comprises a fracture portion which protrudes toward a corresponding vent hole of the plurality of vent holes and is configured to be fractured as an internal pressure of a corresponding battery cell of the plurality of battery cells rises to a set pressure or more, and
each of the plurality of capsules comprises a groove into which the fracture portion is inserted.

10. The battery module as claimed in claim 2, wherein the fixing member comprises a cell sheet between the first body and the plurality of battery cells and having two opposing surfaces fixed to the first body and the plurality of battery cells, respectively.

11. The battery module as claimed in claim 10, wherein a longitudinal direction of the cell sheet is parallel to an arrangement direction of the plurality of capsules.

12. The battery module as claimed in claim 10, wherein the cell sheet comprises a pair of cell sheets, and
the pair of cell sheets are each arranged at one of two opposing sides of the plurality of capsules.

13. The battery module as claimed in claim 2, wherein the blocking member further comprises a hinge connected to the first body and the second body and configured to support the second body to be rotatable with respect to the first body.

14. The battery module as claimed in claim 13, further comprising a busbar holder inside the housing and configured to support a busbar electrically connected to the plurality of battery cells,
wherein a central axis of the hinge is between the second body and the busbar holder.

15. The battery module as claimed in claim 14, further comprising a support member between the plurality of battery cells and the busbar holder and configured to support the busbar holder with respect to the plurality of battery cells.

16. The battery module as claimed in claim 15, wherein the support member is elastically deformable.
